(19) United States
(12) Patent Application Publication
(10) Pub. No.: US 2010/0063641 A1
(43) Pub. Date: Mar. 11, 2010

(54) METHOD AND SYSTEM FOR IMPROVED ENERGY UTILIZATION OF A LARGE BUILDING OR FACILITY

(75) Inventor: Anno Scholten, Grapevine, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: NovusEdge, Inc., Austin, TX (US)

(21) Appl. No.: 12/207,243

(22) Filed: Sep. 9, 2008

(51) Int. Cl. G06F 1/32

(52) U.S. Cl. 700/287; 700/295; 700/296

(57) ABSTRACT

A method and system for improved energy utilization within a building or facility. The building or facility includes one or more systems each controlling one or more energy consuming devices initially operated with a normal energy consumption. The method includes receiving notification of an energy event requiring a reduction of energy consumption within the building or facility, determining an occupancy of one or more areas of the building or facility using at least one of the one or more energy consuming devices, initiating an energy reduction mode upon receipt of the notification of an energy event, and terminating the energy reduction mode at the conclusion of the energy event. The energy reduction mode initiation includes sending a first communication to at least one of the one or more systems requesting the respective systems to operate one or more of the energy consuming devices with a reduced energy consumption during the energy reduction mode. The first communication includes the determined occupancy of the one or more areas of the building or facility. The energy reduction mode termination includes sending a second communication to at least one of the one or more systems requesting the respective systems to operate one or more of the energy consuming devices with the normal energy consumption at the conclusion of the energy event.

### BACKGROUND OF THE INVENTION

1. Field of the Invention

The present invention is generally related to energy consumption, and more particularly to a method and system for improved energy utilization of a large building or facility.

2. Discussion of the Background

In the United States and other areas of the world electrical power distribution occurs over what is known as a “power grid.” A power grid is an expansive network of interconnect high-voltage power transmission lines, power generating stations and distribution substations. The stations and substations are owned by various energy providers, such as utility companies, which manage the distribution of power to various sectors (or regions) of the power grid. Consumers, including, without limitation, commercial, industrial and residential consumers, are typically provided electricity directly or indirectly through service lines. Depending on the type of consumer, the service line may be connected to a lower-voltage distribution line that is stepped-down via transformers before reaching the consumer.

Electrical demand over the power grid is generally dictated by the consumer' use of electricity consuming devices. The power grid is designed to be a balanced system encompassing a number of energy providers whose contributions vary as necessary in order to meet the overall requirements of the consumers.

There currently exist numerous problems related to the production and distribution of energy over the power grid in the United States and other areas of the world. As the population grows in these areas, the energy demands also increases. The energy demand is made worse by the increased utilization of energy consuming devices. Millions of energy consuming devices are in use today with more and more of these devices, such as computers, monitors, LCDs, plasma screens, telephones, answering machines, facsimile machines and the like, running at all times. It is also not uncommon for consumers to operate multiple occurrences of the same type of device, such as multiple computers, which increases energy consumption. However, there exists a finite amount of energy capability over a power grid. The energy capability is limited by various factors, including, without limitation, the varied distribution capabilities over the transmission lines of the power grid and the energy production capability of the power providers. Because of these limitations and the ever increasing energy demand by consumers, energy demand is sometimes equal to the energy capability over the power grid. Referring to FIG. 2, an exemplary chart illustrating hypothetical power consumption over a power grid over time is shown. As illustrated in this exemplary chart, the power consumption reached peak capacity 42 (i.e., the energy demand was equal to the energy capability) at times 42a-42n. Currently, in the United States there are only about 100 hours per year in which the energy demand reaches peak capacity over the power grid. However, left unchecked, the number of hours at peak capacity over the power grid is expected to grow.

There are two fundamental ways to address the peak capacity issue over the power grid. The first is to increase the current distribution capability of the transmission system. This approach faces several challenges including resistance at the Federal, state and local regulatory levels, significant expense, and difficulty gaining right of way for expansion of the transmission system. In fact, the approval period due to regulations for a new energy production facility is often longer than its construction period. Further, millions of dollars are typically required to finance the construction of a large electricity production facility. All of these factors tend to delay construction and thereby increase the costs associated with the electricity production facility which tends to reduce the feasibility of its construction.

The second approach is to reduce the electrical demand during peak usage. This approach is not mutually exclusive with the first approach. Voluntary reductions in demand are attempted through the use of “realtime pricing” or “demand pricing” of demand customers. With demand pricing, there is a financial disincentive to consuming energy, and/or a financial incentive to using less energy, during high use periods.

Independent system operators, regional transmission organizations and distribution companies (collectively referred to herein as “ISO”), monitor the energy capacity of various sections or regions of the power grid. When the energy demand is expected to reach peak capacity of a section or regions of the power grid, an ISO can request that its demand customers, which may include industrial, commercial and residential consumers, reduce their energy consumption. The demand customers may be financially compensated for reducing their energy consumption. Alternatively, if a demand customer doesn't reduce its energy consumption, then it may be financially penalized. Thus, a system of carrots and sticks is used to reduce energy consumption over the power grid.

Referring to FIG. 3, an exemplary chart of power consumption trends in the United States by different types of consumers over the power grid is shown. The overall power consumption trend of commercial customers, residential customers and industrial customers are represented by lines 52, 54 and 56, respectively. Commercial consumers 52 include, without limitation, commercial buildings and commercial retail. As FIG. 3 illustrates, the overall power consumption trends of commercial consumers 52 and residential consumers 54 are increasing and left unchecked will exceed the peak capacity of the power grid within several years. However, the overall power consumption trend of industrial consumers 56 has reached a plateau partly due to the number of industrial plants that have been transferred overseas in recent years.

Referring to FIG. 1, a block diagram illustrating typical systems of a large building or facility is shown for exemplary purposes. Large buildings or facilities 10, such as commercial buildings, commercial retail, industrial facilities and large residences, typically include one or more systems which are configured to independently manage different aspects of the building or facility 10. For example, a large building or facility 10 may include, without limitation, building automation system 12, security system 20 and life and safety system 28. A building automation system 12 typically manages the air conditioning and heating systems (“HVAC”) 14, the power supply and digital generation systems (“UPS/DG”) 16, and the electrical systems 18 associated with the building or facility 10. A security system 20 typically manages the card access devices 22, recording devices 24, such as closed circuit televisions (“CCTV”), digital video recorders (“DVR”) and network video recorders (“NVR”), and the intrusion detection devices 26, such as motion detectors, associated with the building or facility 10. A life safety system 28 typically manages the fire and smoke detectors 30 associated with the building or facility 10. These systems (12, 20 and/or 28) are typically operated using a combination of software and hardware. Historically, the building automation system 12, security system 20, and the life and safety system 28 have been proprietary in nature. Recently, open architectures (e.g., the Internet protocol (“IP”)) have been utilized in newer versions of building automation systems 12 and security systems 20. However, Life safety systems 28 generally remain proprietary due to the strict regulations associated with fire prevention systems.

Buildings and facilities generally do not operate with any real knowledge of actual usage of the building or facility 10. Their operation is typically based on the initial design parameters for the building or facility 10. Accordingly, the main energy systems (lighting, HVAC, elevators, parking, and the like) are typically started and stopped on a fixed time schedule that has been predetermined on anecdotal information of the “average” building occupant arriving and leaving. Some buildings or facilities 10 may include “after hours” request systems that require tenants to manually press a button to provide a fixed window of two or more hours of lighting and HVAC. However, these systems do not provide detailed analysis nor profiling capabilities to determine where, when and how building occupants actually use the facility, nor long term profiling to determine if actual usage is consistent with design parameters.

The energy demand for large buildings or facilities 10 is typically determined by the energy consumption of the devices that are managed by the building automation system 12, security system 20, and the life and safety system 28. However, in a large building or facility 10, reducing the power of any one device may effect other unrelated devices. For example, reducing the light intensity in a room may indirectly effect that room's temperature. The configurations of the building automation system 12, security system 20, and the life and safety system 28 of a large building or facility 10 are generally complex. While these systems (12, 20 and/or 28) are not in communication, the devices they control may indirectly effect other devices controlled by that system (12, 20 and/or 28) or other systems (12, 20 and/or 28). As such, there currently exists no efficient way to reduce the overall energy demand of the devices controlled by these systems. This is also true with respect to commercial retail, industry and large residences. Further, arbitrarily reducing power to the devices of a large building or facility 10 tends to disturb and irritate the occupants or tenants of the building or facility.

Thus, there currently exist deficiencies in energy utilization within a large building or facility in the United States and other areas of the world.

### SUMMARY OF THE INVENTION

Accordingly, one aspect of the present invention is to provide a method for improved energy utilization of a building or facility. The building or facility includes one or more systems each controlling one or more energy consuming devices initially operated with a normal energy consumption. The method includes receiving notification of an energy event requiring a reduction of energy consumption within the building or facility, determining an occupancy of one or more areas of the building or facility using at least one of the one or more energy consuming devices, initiating an energy reduction mode upon receipt of the notification of the energy event, and terminating the energy reduction mode at the conclusion of the energy event. The energy reduction mode initiation includes sending a first communication to at least one of the one or more systems requesting the respective systems to operate one or more of the energy consuming devices with a reduced energy consumption during the energy reduction mode. The first communication includes the determined occupancy of the one or more areas of the building or facility. The energy reduction mode termination includes sending a second communication to at least one of the one or more systems requesting the respective systems to operate one or more of the energy consuming devices with the normal energy consumption at the conclusion of the energy event.

Another aspect of the present invention is to provide a system for improved energy utilization of a building or facility. The building or facility includes one or more systems each controlling one or more energy consuming devices initially operated with a normal energy consumption. The system includes an automated demand response unit in communication with at least one of the one or more systems, and an network interface in communication with the automated demand response unit and an independent system operator. The automated demand response unit is configured to receive notification of an energy event, via the network interface, requiring a reduction of energy consumption within the building or facility, determine an occupancy of one or more areas of the building or facility using at least one of the one or more energy consuming devices, initiate an energy reduction mode upon receipt of the notification of the energy event and terminate the energy reduction mode at the conclusion of the energy event. The energy reduction mode initiation includes sending a first communication to at least one of the one or more systems requesting the respective systems to operate one or more of the energy consuming devices with a reduced energy consumption during the energy reduction mode. The first communication includes the determined occupancy of the one or more areas of the building or facility. The energy reduction mode termination includes sending a second communication to at least one of the one or more systems requesting the respective systems to operate one or more of the energy consuming devices with the normal energy consumption at the conclusion of the energy event.

Yet another aspect of the present invention is to provide a method for improved energy utilization of a building or facility. The building or facility includes one or more systems each controlling one or more energy consuming devices initially operated with a normal energy consumption. The method includes determining an occupancy of one or more areas of the building or facility using at least one of the one or more energy consuming devices, initiating an energy reduction mode, and terminating the energy reduction mode. The energy reduction mode initiation includes sending a first communication to at least one of the one or more systems requesting the respective systems to operate one or more of the energy consuming devices with a reduced energy consumption during the energy reduction mode. The first communication includes the determined occupancy of the one or more areas of the building or facility. The energy reduction mode termination includes sending a second communication to at least one of the one or more systems requesting the respective systems to operate one or more of the energy consuming devices with the normal energy consumption.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating typical systems of a large building or facility known in the prior art;

FIG. 2 is an exemplary chart illustrating the hypothetical power consumption of a section of a power grid over time;

FIG. 3 is an exemplary chart of power consumption trends by different types of consumers over the power grid in the United States;

FIGS. 4 and 5 are block diagram illustrating systems of a large building or facility in accordance with an embodiment of the present invention;

FIGS. 6 and 7 are flow charts illustrating a method for reducing the energy consumption of a large building or facility in accordance with an embodiment of the present invention;

FIGS. 8A-8C are database tables in accordance with an embodiment of the present invention;

FIG. 9 is a sequence chart in accordance with an embodiment of the present invention; and

FIGS. 10 and 11A-11C are system diagrams in accordance with an embodiment of the present invention.

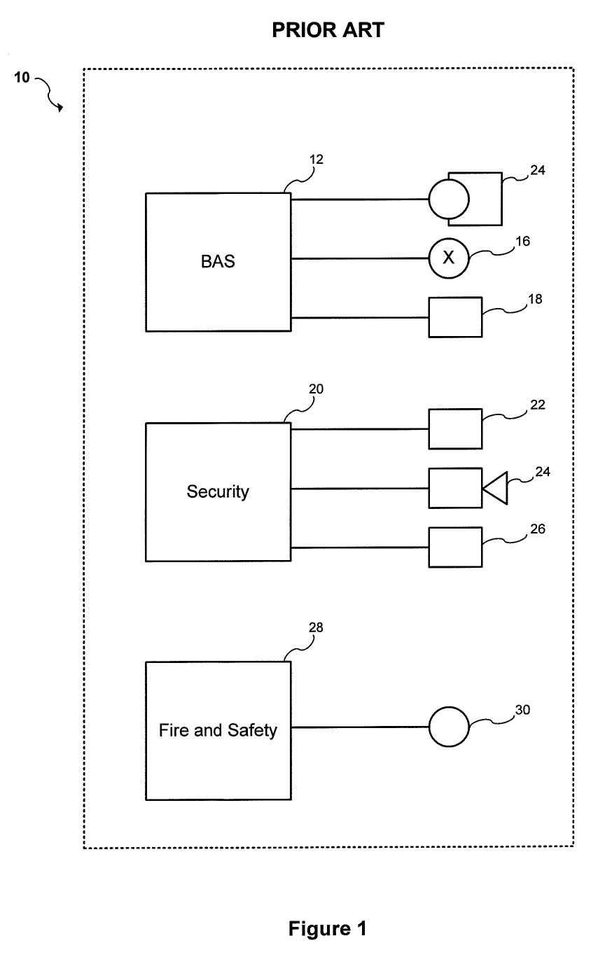

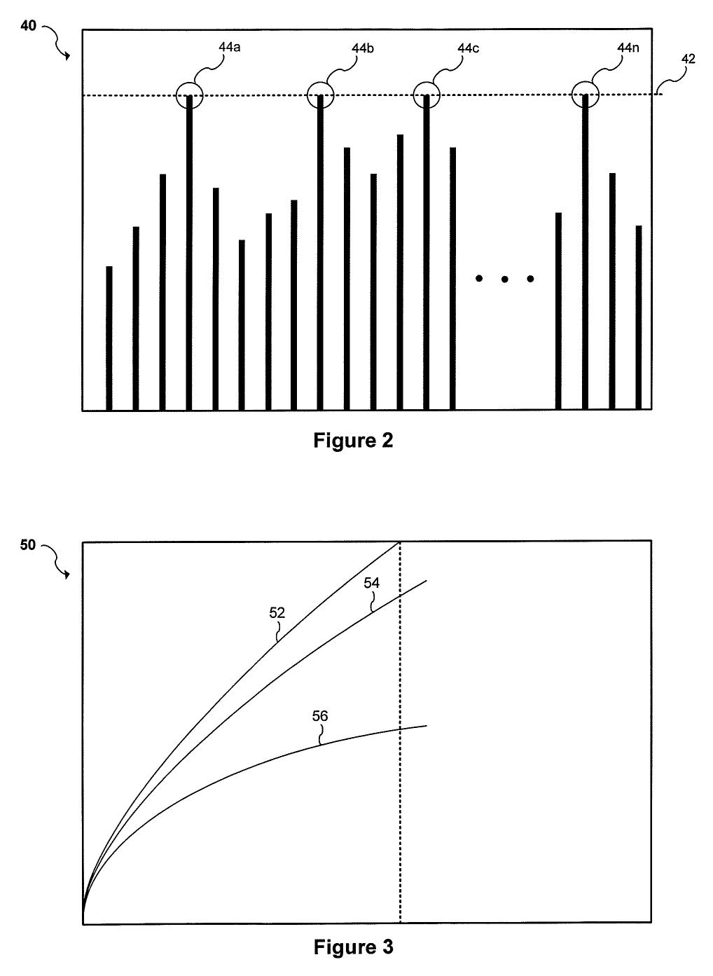

### DETAILED DESCRIPTION THE PREFERRED EMBODIMENTS

Referring now to the drawings, wherein like reference numerals designate identical or corresponding parts throughout the several views, preferred embodiments of the present invention are described.

Analysis of actual building usage by its occupants and equipment (assets) can provide the building and building manager valuable information on how best to optimize the functions of the building for those occupants and equipment. According to the present invention, automatic adjustment of building functions based on actual occupant or equipment usage may be provided through asset aware network technology that integrates data from several building systems. This usage data can may used in real time or near real time to make automatic adjustments to building functions such as temperature control, lighting management, air flow management, parking management and more intelligent management of demand response initiatives.

Data from asset aware networks may also be used for profiling building use by its occupants to allow building owners and managers to provide better maintenance analysis of building systems. It also allows building or facility managers to provide better competitive negotiations with specific occupants.

Ideally, asset aware networks is integrated into all building automation systems (BAS) including the lighting control system, HVAC management systems, UPS and generator back up systems, elevator systems, and the like. However, it is to be understood that the present invention does not require that all building automation systems be integrated and that, instead, asset aware networks may be integrated into any number of systems.

Existing building systems may be configured to provide actual building usage by building occupants. Such building systems include, without limitation, access control systems, intrusion detection systems and video monitoring systems.

Access control systems (ACS)—Strategic placement of card readers to provide access to certain areas of the building or facility may be used to provide both real time and historical occupant usage of each area. Access control systems typically record point of use (front door, garage, server room, etc), who used the area and when they used the area. Access control systems may also be configured to determine if an area is currently in use and provide a historical profile of usage in an area with specific individual details.

Card readers can be distributed throughout the facility to collect additional usage data. For example, a card reader located in each tenant suite may be configured to initiate the start of certain energy systems (lighting, HVAC, etc) when occupants arrive and to recognize extended after hours use. The ACS may also be configured to provide individual data on each tenant when the systems are started and by whom.

Intrusion detection systems (IDS)—Strategic placement of IR motion detectors and door contacts used to detect when doors are opened and closed, may also be configured to provide occupancy information as well as intrusion detection when the facility should be secured.

Video monitoring systems (VMS)—Strategic placement of video cameras throughout the facility in combination with video analytics software may be used to provide extensive occupant usage data. This data may include information such as a person count into and out of an area, the number of people assembling in certain areas, periods of time people stay assembled in certain areas, number of cars entering and leaving parking facilities, and the like.

Asset aware network systems (ACS, IDS and VMS) provide building occupant actual and historical usage data to the other building automation systems (BAS) and the building manager via asset aware network (AAN) applications.

Specific AAN applications include, without limitation, demand response asset awareness, CO² management, elevator management, after hours energy management, parking management, heat source analysis based on IR from cameras, predictive energy use for cleaning crews, occupancy “profiling,” vending machine usage, and key management energy usage.

Demand response asset awareness—Demand side energy management for demand response (DSM for DR) typically provides load shaping strategies such as global temperature set point adjustment and load curtailment. Asset aware network systems (AAN-S) may be used to provide occupant data such that DSM for DR strategies can be applied to least occupied areas thereby minimizing occupant discomfort. Specific strategies that would be improved using asset aware information include, without limitation: lighting of common areas and office areas, and HVAC global set point adjustment, CHW temp reset, CHW current limit, fan VFD limit, duct static reset, VAV shut down, SAT reset, chiller demand limit, boiler lockout and pre-cool.

CO² management—American Society of Heating, Refrigerating and Air-Conditioning Engineers (ASHRAE) standards require CO² management of occupied spaces to ensure sufficient fresh air is maintained for the number of occupants in the space. Typically, this is provided by CO² sensors that measure total CO² in the space and adjusts the fresh air systems accordingly. The lag in these control systems causes significant energy wastage. ASHRAE provides alternative strategies based on actual occupancy. Asset aware network systems may be used to provide accurate occupancy numbers based on strategically positioned cameras and people counting algorithms within the AAN-S.

Elevator management—Elevator management is based on data from both floor call buttons located outside the elevator and floor destination buttons located within elevator. AAN-S may be used to determine the actual number of people waiting in an elevator lobby using strategically placed cameras and people counting. Thereby, the number of elevators required to service actual occupancy requirements may be improved. For instance, one or more elevators may be powered off during off-peak times. Historical profiling may be used during DR events to provide significant load curtailment loads.

After hours energy management—After hours energy (lighting, HVAC, etc) can be managed more accurately using AAN-S. Video cameras may be configured to detect motion in specific tenant common areas like lobbies and reception to initiate after hours energy requests. Strategically placed card readers in tenant suites may be used to provide detailed information of actual tenant requests.

Parking management—Significant energy is wasted by underground and multi floor parking facilities as cars drive around to find open spaces. Energy is wasted in running exhaust fans to extract excess CO and CO² from running vehicles as drivers look for spaces. Video cameras in combination with video analytic software may be used to determine empty bays within a garage. Further, actual occupancy data of parking garages can be used to modulate parking lighting to further reduce energy. Specifically, video cameras may be configured be used to determine if people are actually present on a particular parking level and to reduce lighting levels when that particular parking level is unoccupied. Lighting may be configured to be restored to 100% lighting upon any movement or sound for security issues. The same cameras will also be used for normal security functions.

Heat source analysis based on IR from cameras—IR cameras are primarily used for security in low lit applications. However, IR cameras may also be configured to provide thermal load analysis of occupied space. This would include both running equipment like computers, printers and people.

Predictive energy use for cleaning crew—Office cleaning crews require lighting to do their job. Typically, cleaners are typically trained to that ensure all lighting is extinguished at the end of their routine for a particular tenant. According to the present invention, video analysis may be used to ensure that all lighting is switched off after a delay of no cleaner activity. Cleaners could also wear video identifiable identification such that they can easily be distinguished from normal tenants.

Occupancy “Profiling”—Real time or near real time tenant building usage provides may be created in real time or near real time using video and card access analysis. For example, the tenant on a particular floor may have a pattern of being fully occupied Mondays and Tuesdays, 50% occupied on Wednesdays to Fridays, and 25% occupied on Saturdays. Tenant building usage would help the building manager provide better services and have better cost analysis of their building or facility. For example, actual tenant profiles would allow the building manager to: negotiate a different energy usage profile and invoicing for the tenant; pre-determine if the tenant is growing or shrinking the number of people working for them; determine tenant traffic patterns that would allow the tenant better facility layout and space planning to improve the tenant's productivity; determine actual cleaning supplies required and restroom cleaning schedules; and determine predictive wear and tear on the building in specific areas, including energy systems, lighting replacement and flooring replacement.

Vending machine usage—Using video analysis, actual vending machine usage could provide energy savings strategies at either peak demand events or for general energy efficiencies. Low use vending machines lighting can be extinguished and automatically restored when someone approaches the vending machine.

Key management energy usage—HVAC and mechanical service technicians frequently override energy management strategies or leave machinery running in override after routine service visits. This causes excess energy use or the inability for DR events to override these items. By providing card access to manage the unlocking of the control panels and monitoring the service technicians ID, emails can be generated based on the technician's actual activities in the panel.

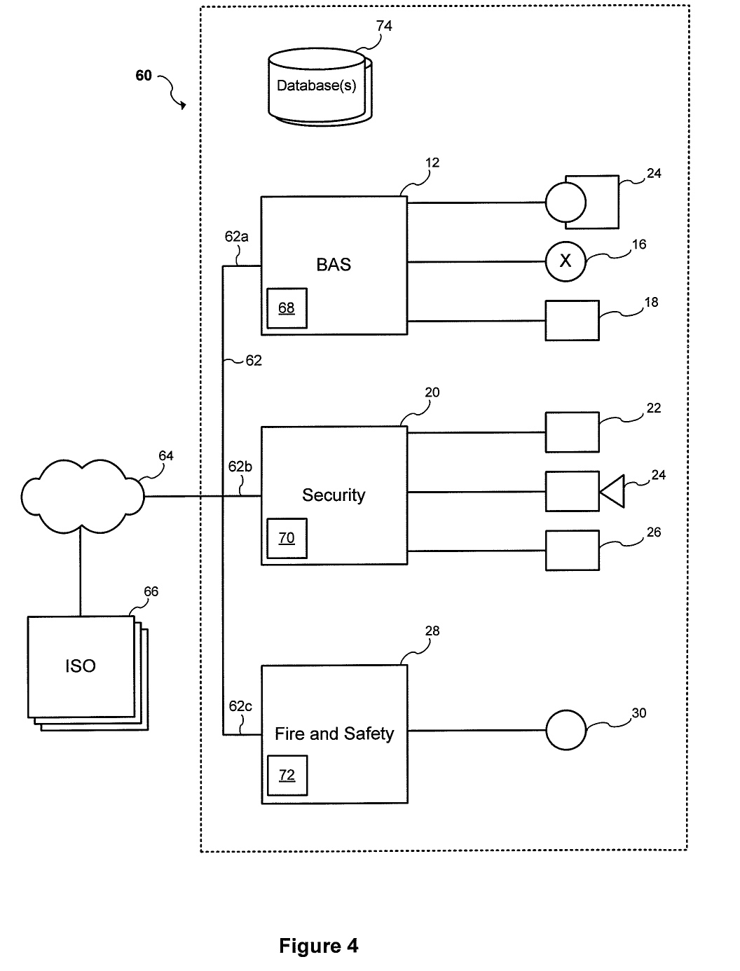

Referring to FIG. 4, a block diagram illustrating systems of a large building or facility in accordance with an embodiment of the present invention is shown. As previously discussed, a large building or facility 10 may include, without limitation, a building automation system 12, a security system 20, and a life and safety system 28.

According to one embodiment of the present invention, one or more of systems (e.g., the building automation system 12, security system 20, and/or the life and safety system 28) are in direct communication with an ISO 66 over a network 64 via one or more communication lines 62. In an alternate embodiment of the present invention, these systems are indirectly in communication with the ISO 66. Under the alternate embodiment, a human operator may be required to initiate the reduction of energy consumption for the devices using, for instance, a graphical user interface (GUI).

As shown in FIG. 4, the ADR (68, 70 and/or 72) for each system (12, 20 and/or 28) may be configured as a plug-in or other internal arrangement within the building automation system 12, security system 20, and/or the life and safety system 28.

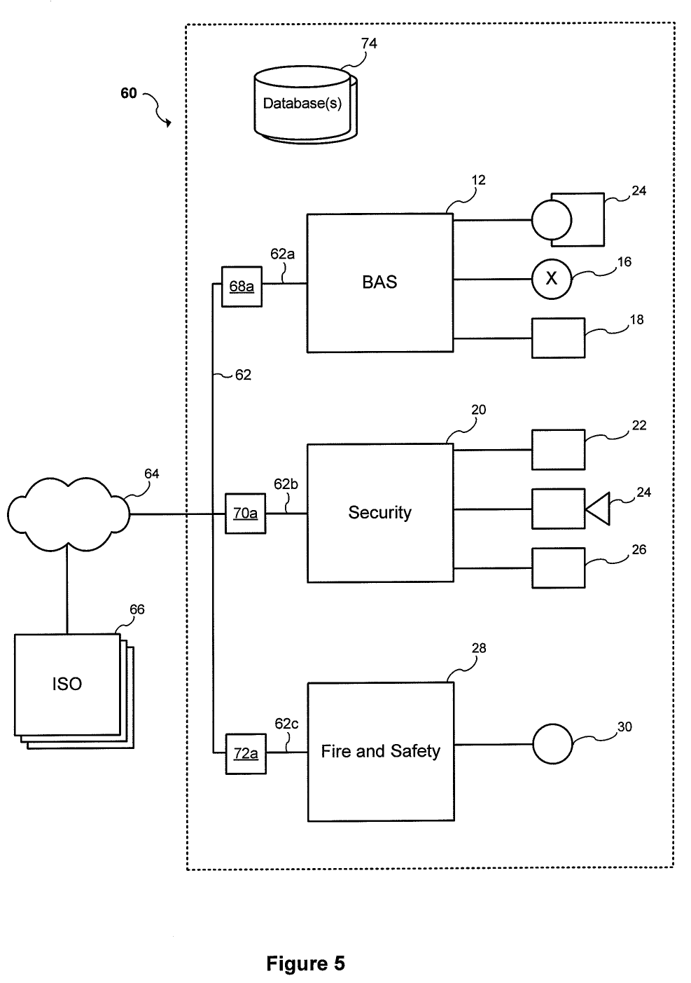

Alternatively, as shown in FIG. 5, the automated demand response software for the respective systems (12, 20 and/or 28) may be configured externally, such as within an external ADR unit (68a, 70a and/or 72a) in communication with the respective building automation system 12, security system 20, and/or life and safety system 28. According to this alternative embodiment, the external ADR units (68a, 70a and/or 72a) include a microprocessor, memory, and a network and/or local controller in communication with the respective systems (12, 20 and/or 28). The external ADR units (68a, 70a and/or 72a) are in communication with one or more of the systems (e.g., the building automation system 12, security system 20, and/or the life and safety system 28) via communication lines 62a, 62b and 62c. Communication lines 62, 62a, 62b and 62c may include, without limitation, wired and wireless communication. Communication lines 62a, 62b and 62c may be directly or indirectly connected to the respective systems (12, 20 and/or 28). The network and/or local controller receives incoming communications from an ISO 66, over network 64 via one or more communication lines 62, in various protocols, including, without limitation, RS232, RS485 and Ethernet and communicates with the respective systems (12, 20 and/or 28), via one or more communication lines (62a, 62b and/or 62c), using a protocol that is understood by that system (12, 20 and/or 28). For example, in one embodiment, the external ADR units (68a, 70a and/or 72a) communicate with one or more systems (12, 20 and/or 28) using the IP protocol.

The ADR (68, 70 and/or 72) is configured to receive a notification of an energy event from an ISO 66 either directly or indirectly and, upon receipt, to communicate with the respective system in order to reduce the energy consumption of one or more of the devices being controlled by the respective systems (12, 20 and/or 28). Notably, the ADR does not attempt to directly reduce the power consumption of any device, but, instead, uses the software and/or hardware of the respective system (12, 20 and/or 28) to reduce the energy consumption of the device. Simply put, the complex configuration of the systems (12, 20 and/or 28) is not ignored, but, instead, utilized in the reduction of the energy consumption of the devices. Accordingly, reducing the energy consumption of a device does not result in unexpected effects with other devices because the energy reduction remains within the logic constraints of the respective system (12, 20 and/or 28) configuration, as originally programmed or subsequently revised.

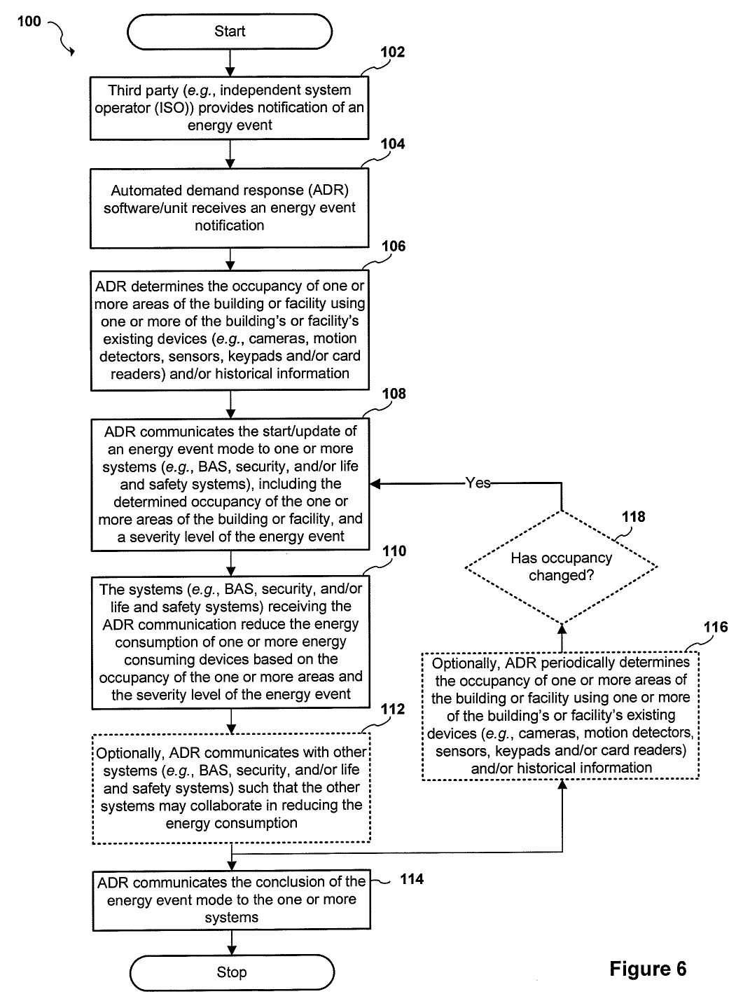

Referring to FIG. 6, a flow chart illustrating a method for reducing the energy consumption of a large building or facility in accordance with an embodiment of the present invention is shown. When it is determined that the energy demand will exceed the peak capacity of a section of the power grid, a power grid operator, such as an ISO 66, transmits an energy event notification to a demand customer, such as a large commercial building, via one or more communication lines 62, as shown at block 102. As shown at block 104, the ADR (68, 70 and/or 72) receives an energy event notification from the power grid operator. The ADR (68, 70 and/or 72) then determines the occupancy of one or more areas of the building or facility using one or more of the building's or facility's existing devices (e.g., cameras, motion detectors, electronic and thermal sensors, keypads and/or card readers), as shown at block 106.

For instance, a camera is normally used for security purposes. According to one embodiment of the present invention, images from the same camera are inspected by the ADR (68, 70 and/or 72) and/or software executed by the ADR (68, 70 and/or 72) and a determination is made as to the occupancy of that area. The areas may include, without limitation, individual rooms and common areas, tenant offices and floors. It is to be understood that the present invention is not to be limited to the building's or facility's existing devices, but that, instead, additional devices and possibly new technologies may be added for the purpose of determining the occupancy of the areas and/or other actions consistent with the present invention.

Other actions are also possible within the scope of the present invention. For example, images from a camera may be inspected using facial recognition software known in the art in order to determine if a particular person is present in an area of the building or facility. Likewise, a keypad and/or card reader may also be used in order to determine if a particular person is present. The energy consumption of the devices in a particular office, boardroom, bathroom or living space may be adjusted by the present invention, as detailed below, based on a particular person's identification and location. For example, the light intensity may be increased and the temperature lowered in a particular person's office upon a detection of that person entering the building, facility and/or parking garage. Historical usage information of a particular person or an area of the building or facility may be stored in one or more databases 74. Such historical information may be used to predict expected energy demands and/or optimize the energy utilization of various devices of the building or facility. Artificial intelligence (genetic algorithms and fuzzy logic) using the historical information allows the ADR (68, 70 and/or 72) to become smarter over time and to improve the overall energy costs of the building or facility. As shown at block 108, the ADR (68, 70 and/or 72) then communicates with the building's or facility's systems (12, 20 and/or 28) and requests that the respective system (68, 70 and/or 72) reduce the energy consumption with respect to the power grid of one or more of the devices controlled by that system (12, 20 and/or 28). The communication may include, without limitation, the determined occupancy of the one or more areas of the building or facility, and the severity of the energy event. The severity of the energy event may be represented by a numeric code. For instance, the following codes may be used:

ENERGY EVENT
SEVERITY
LEVEL01
LEVEL02
LEVEL03
LEVEL04
LEVEL05
LEVEL06
LEVEL07
LEVEL08
LEVEL09
LEVEL10

It is to be understood that any alpha, numeric or alphanumeric code, symbol or identifier may be used to represent the severity of the energy event within the scope of the present invention.

In one embodiment, communicating with the building's or facility's systems involves executing appropriate functional calls within the respective system (12, 20 and/or 28) to reduce the energy consumption of the respective devices. In another embodiment, communicating with the building's or facility's systems involves transmitting a code or communication to the respective system (12, 20 and/or 28). In yet another embodiment, communicating with the building's or facility's systems involves the transmission of an electrical signal to the respective system (12, 20 and/or 28).

As shown at block 110, the systems (12, 20 and/or 28) receiving the ADR communication are configured to reduce the energy consumption of one or more energy consuming devices controlled by the respective system. The respective system (12, 20 and/or 28) may reduce the energy consumption based on, without limitation, the determined occupancy of the one or more areas of the building or facility, and the severity of the energy event. For instance, the respective system may reduce the energy consumption of one or more energy consuming devices in those areas determined to be unoccupied.

According to one embodiment, the systems (68, 70 and/or 72) reduce the energy consumption with respect to the power grid by reducing the power consumption of the respective devices. For example, upon request, the lighting may be reduced by fifty percent, the temperature setting for the HVAC may be increased/decreased by several degrees, and/or one or more elevators may be turned off. According to an alternate embodiment, the system (68, 70 and/or 72) reduces the energy consumption with respect to the power grid by engaging an onsite generator and providing self-generated electric power to the respective devices. Thereby, the energy consumption with respect to the power grid is reduced.

According to one embodiment of the present invention, two or more of the systems (e.g., the building automation system 12, security system 20, and/or the life and safety system 28) are inter-connected via communication lines 62a, 62b and 62c, such that the systems (12, 20 and/or 28) collaborate with respect to reducing the total energy consumption of the building or facility 10. Communication lines 62, 62a, 62b and 62c may include, without limitation, wired and wireless communication. Communication lines 62a, 62b and 62c may be directly or indirectly connected to the respective systems (12, 20 and/or 28). Optionally, as shown at block 112, an ADR (68, 70 and/or 72) may also communicate with other ADRs (68, 70 and/or 72) and/or other systems (12, 20 and/or 28) via communication lines 62a, 62b and/or 62c. According to this embodiment, the devices of the different systems (12, 20 and/or 28) may be utilized in order to determine which areas of the building or facility that energy reduction should occur. For example, the cameras and/or card scanners, security pads and/or motion detection devices controlled by the security system 20 may be utilized in order to efficiently determine the occupancies of one or more areas of the building or facility. Historical information from one or more databases 74 may also be used in this determination. The devices in unoccupied areas may be targeted first with respect to energy reduction. For example, the lights may be turned off or reduced in intensity in these unoccupied areas. Additionally, the temperature settings of the HAVC may be reduced/increased, as appropriate, depending on the occupancies of respective area. Thereby, the reduction of energy for these devices is reduced while the impact on occupants or tenants of the large building or facility is minimized. The present invention thus takes into consideration late-night cleaning crews, and off-hour use and/or under use by people within different areas of the building or facility. Such an arrangement may also be utilized by the building or facility 10 internally to reduce power consumption independent of any request by a power grid operator, such as an ISO 66. Thus, this embodiment of the present invention may be used by the building or facility 10 simply to improve its energy utilization and to reduce the cost association with such energy utilization.

Optionally, as shown at block 116, the ADR (68, 70 and/or 72) periodically determines the occupancy of one or more areas of the building or facility using one or more of the building's or facility's existing devices (e.g., cameras, motion detectors, electronic and thermal sensors, keypads and/or card readers). As shown at optional logic block 118, if the occupancy has changed for the respective area, then the updated occupancy is communicated to the respective system (12, 20 and/or 28) and processing continues at block 108.

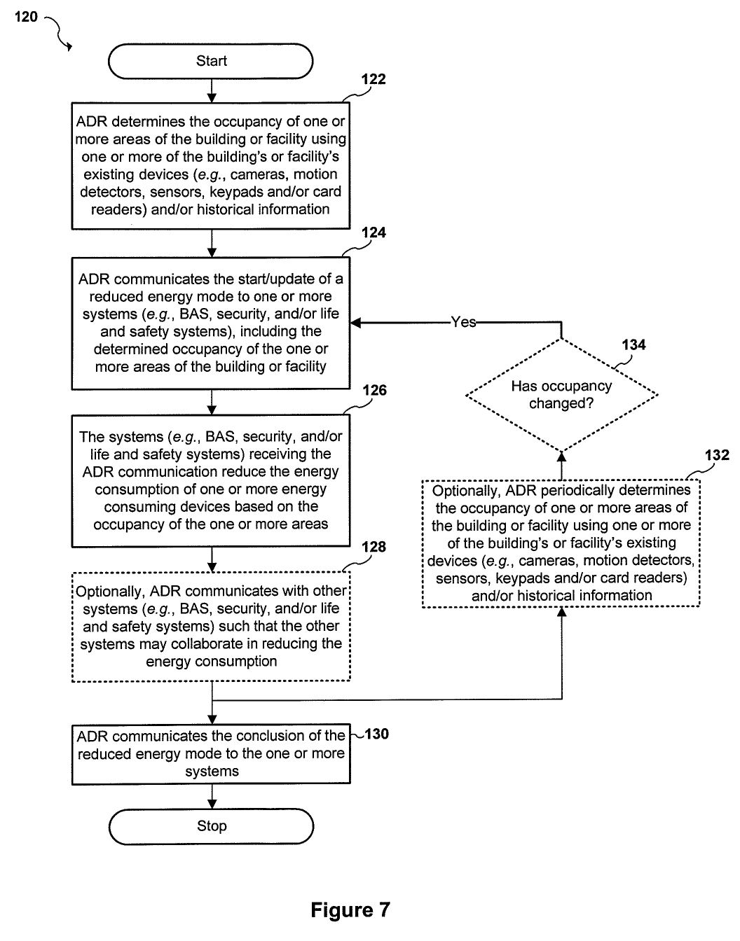

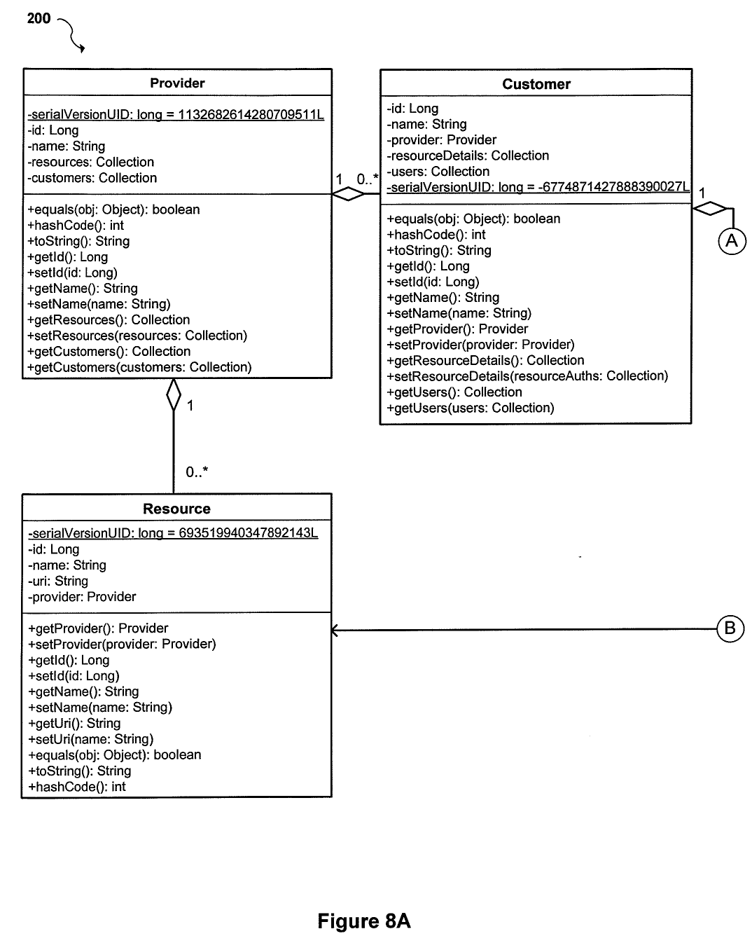

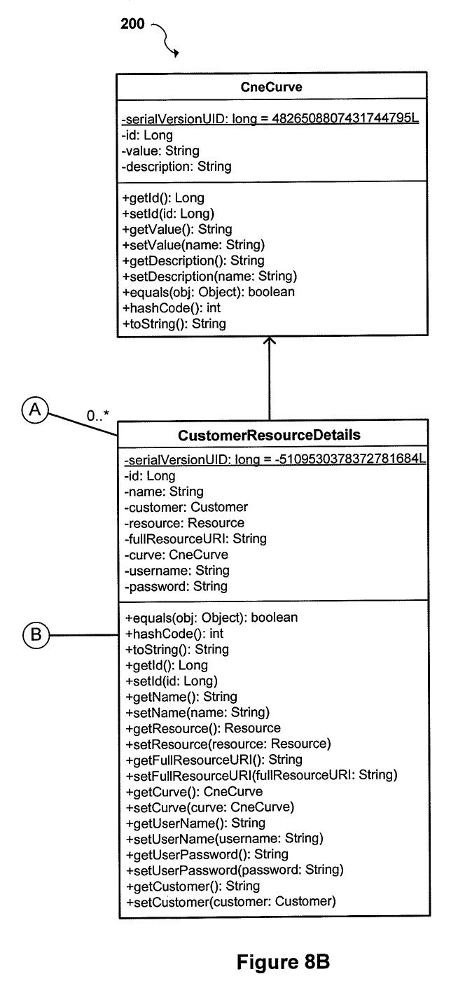

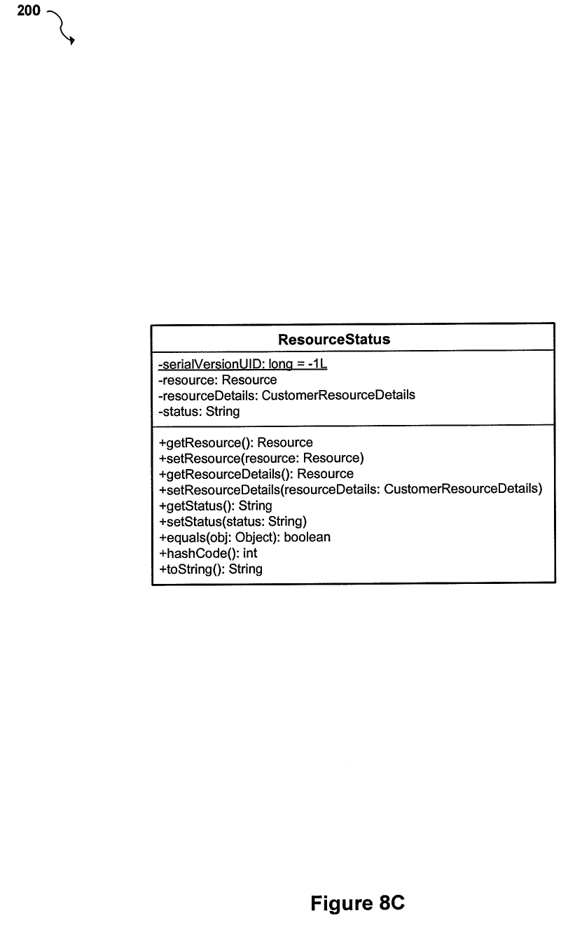

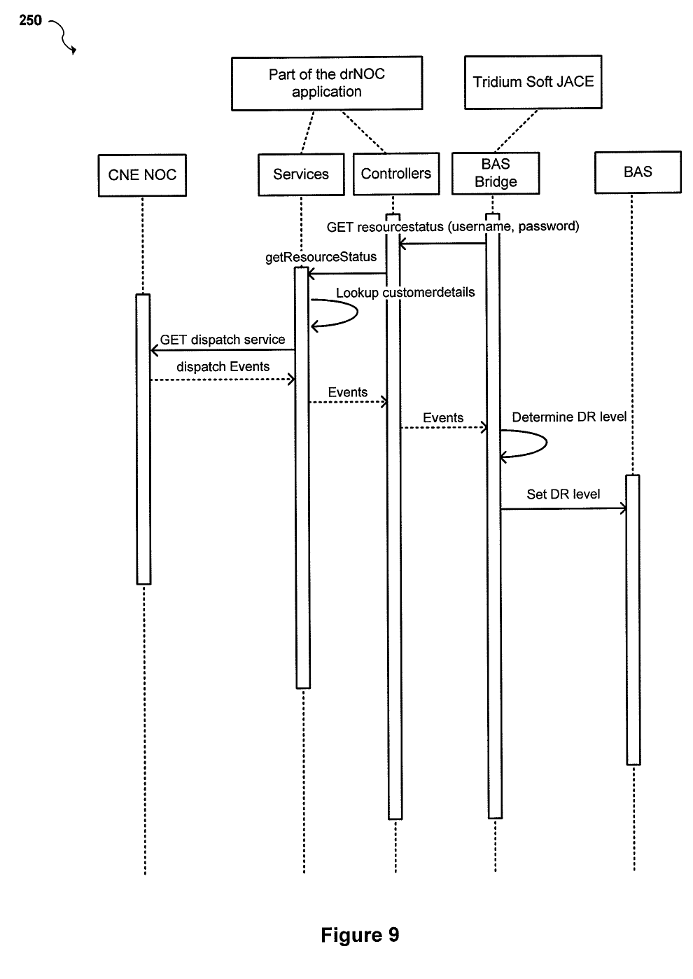

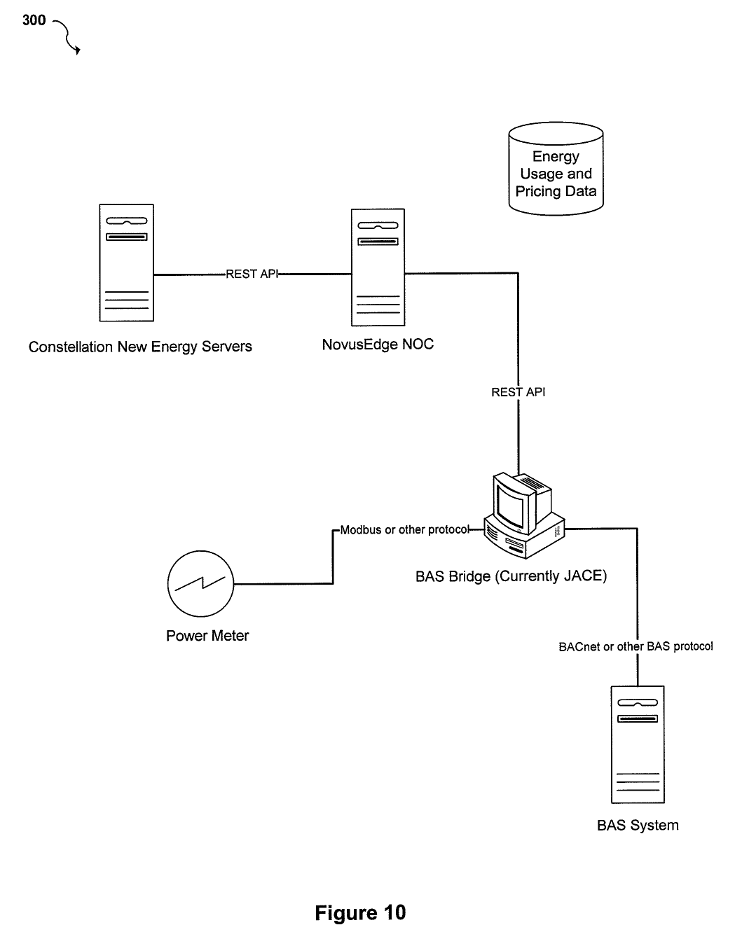

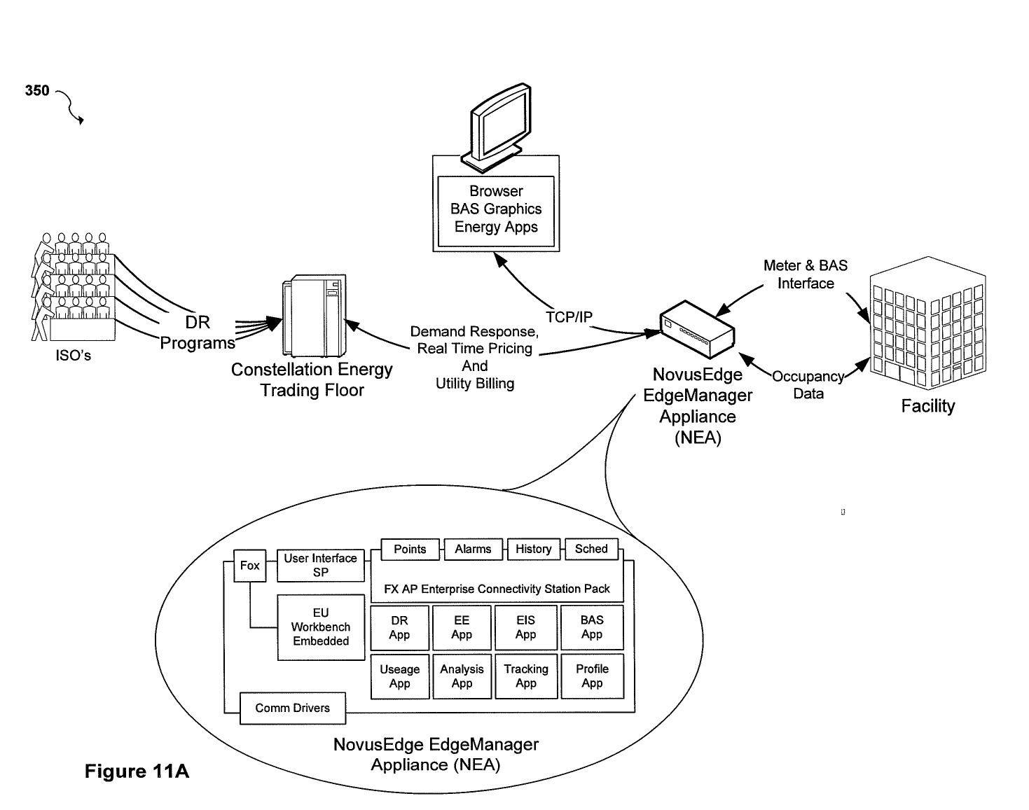

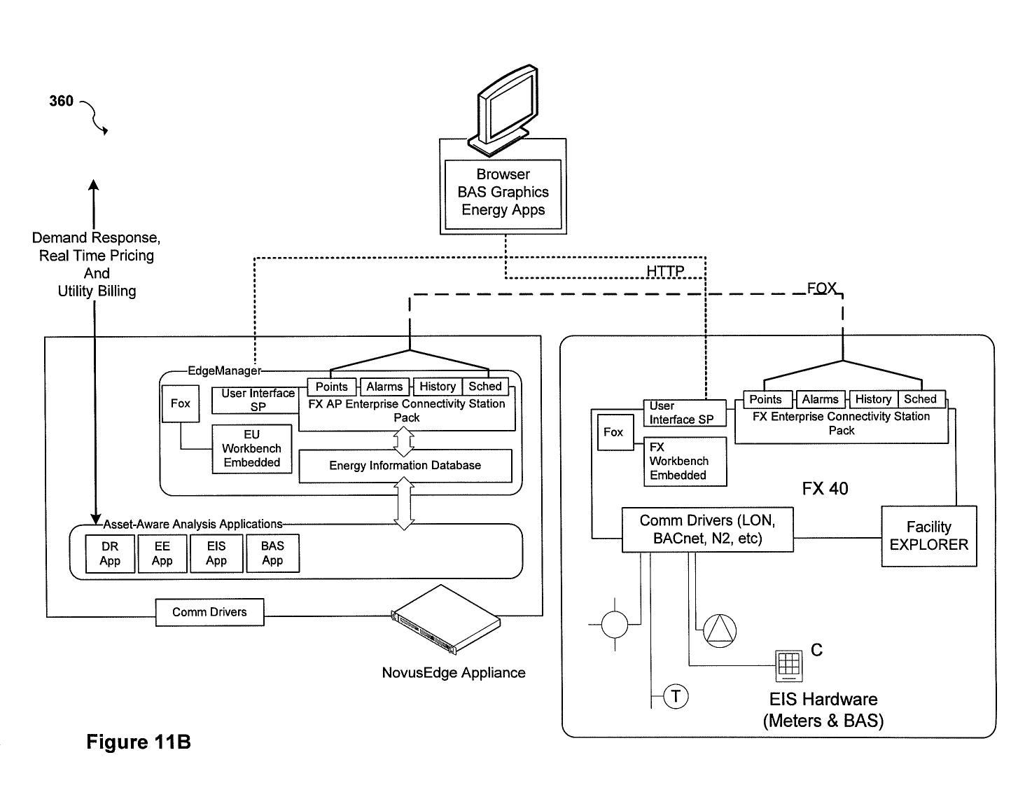

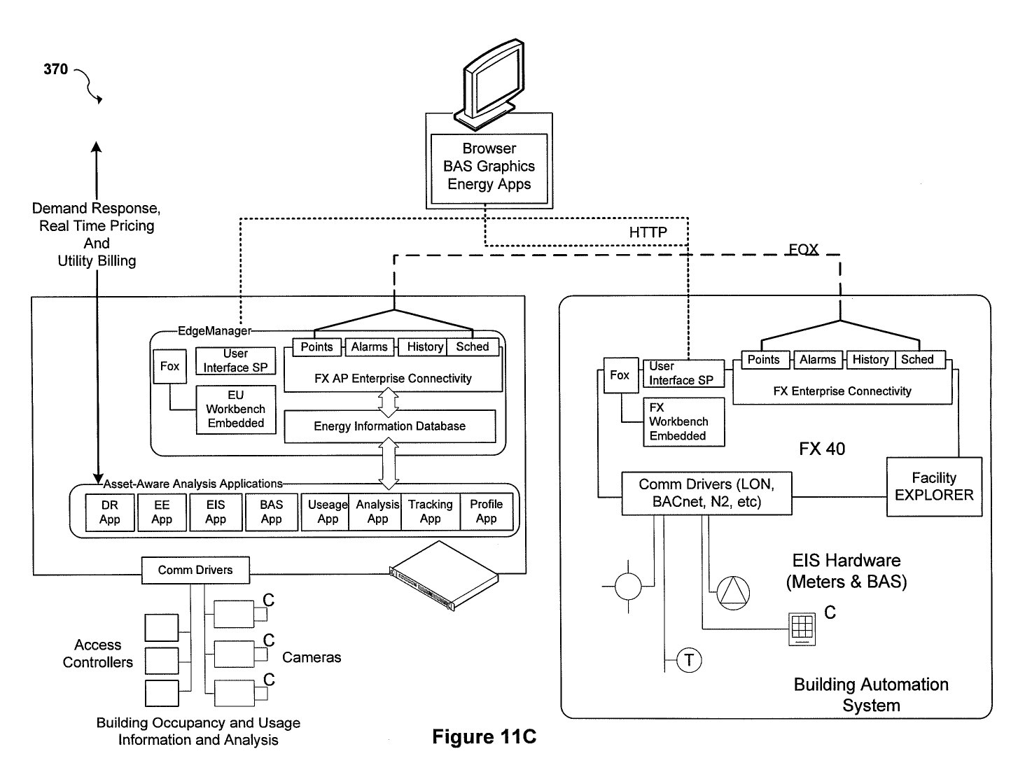

Referring to FIG. 7, a flow chart illustrating another method for reducing the energy consumption of a large building or facility in accordance with an embodiment of the present invention is shown. As shown at block 122, the ADR (68, 70 and/or 72) determines the occupancy of one or more areas of the building or facility using one or more of the building's or facility's existing devices (e.g., cameras, motion detectors, electronic and thermal sensors, keypads and/or card readers).

The ADR (68, 70 and/or 72) then communicates with the building's or facility's systems (12, 20 and/or 28) and requests that the respective system (68, 70 and/or 72) reduce the energy consumption with respect to the power grid of one or more of the devices controlled by that system (12, 20 and/or 28), as shown at block 124. The communication may include, without limitation, the determined occupancy of the one or more areas of the building or facility.

As shown at block 126, the systems (12, 20 and/or 28) receiving the ADR communication are configured to reduce the energy consumption of one or more energy consuming devices controlled by that system. The respective system (12, 20 and/or 28) may reduce the energy consumption based on, without limitation, the determined occupancy of the one or more areas of the building or facility.

Optionally, as shown at block 128, an ADR (68, 70 and/or 72) may also communicate with other ADRs (68, 70 and/or 72) and/or other systems (12, 20 and/or 28) via communication lines 62a, 62b and/or 62c. According to this embodiment, the devices of the different systems (12, 20 and/or 28) may be utilized in order to determine which areas of the building or facility that energy reduction should be targeted.

Optionally, as shown at block 132, the ADR (68, 70 and/or 72) periodically determines the occupancy of one or more areas of the building or facility using one or more of the building's or facility's existing devices (e.g., cameras, motion detectors, electronic and thermal sensors, keypads and/or card readers). As shown at optional logic block 134, if the occupancy has changed for the respective area, then the updated occupancy is communicated to the respective system (12, 20 and/or 28) and processing continues at block 124.

Additionally, the ADR (68, 70 and/or 72) provides a standard functional interface for reducing the power consumption of the devices controlled by the respective systems (12, 20 and/or 28) regardless of the manufacturer of the system (12, 20 and/or 28) and/or internal protocol used by that system (12, 20 and/or 28). Thereby, at least a portion of the power consumption control of the systems (12, 20 and/or 28) may be abstracted from the systems (12, 20 and/or 28).

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A method for improved energy utilization of a building or facility, wherein the building or facility includes one or more systems each controlling one or more energy consuming devices initially operated with a normal energy consumption, the method comprising:
receiving notification of an energy event requiring a reduction of energy consumption within the building or facility;
determining an occupancy of one or more areas of the building or facility using at least one of the one or more energy consuming devices;
initiating an energy reduction mode upon receipt of the notification of the energy event, wherein the energy reduction mode initiation comprises sending a first communication to at least one of the one or more systems requesting the respective systems to operate one or more of the energy consuming devices with a reduced energy consumption during the energy reduction mode, and wherein the first communication includes the determined occupancy of the one or more areas of the building or facility; and
terminating the energy reduction mode at the conclusion of the energy event, wherein the energy reduction mode termination comprises sending a second communication to at least one of the one or more systems requesting the respective systems to operate one or more of the energy consuming devices with the normal energy consumption at the conclusion of the energy event.

2. The method of claim 1, further comprising:
periodically determining the occupancy of the one or more areas of the building or facility using at least one of the one or more energy consuming devices; and
sending an updated occupancy of at least one of the one or more areas of the building or facility to at least one of the one or more systems if the occupancy for the respective area has changed.

3. The method of claim 1, wherein the first communication further includes a severity level of the energy event.

4. The method of claim 1, wherein the at least one of the one or more energy consuming devices is a security camera.

5. The method of claim 4, wherein the security camera is used in combination with a computer program configured to determine the occupancy of the one or more areas of the building or facility.

6. The method of claim 5, wherein the computer program is configured to determine areas devoid of any persons.

7. The method of claim 5, wherein the computer program is configured to determine areas devoid of a particular person.

8. The method of claim 7, wherein the computer program includes facial recognition software configured to identify a particular person.

9. The method of claim 1, wherein the at least one of the one or more energy consuming devices comprises at least one selected from the group consisting of a motion sensor, an electronic sensor, a thermal sensor, a key pad and a card reader.

10. The method of claim 9, wherein the at least one of the one or more devices is used in combination with a computer program configured to determine the occupancy of the one or more areas of the building or facility.

11. The method of claim 1, wherein the one or more energy consuming devices comprise a HVAC.

12. The method of claim 1, wherein the one or more energy consuming devices comprise a lighting device.

13. The method of claim 1, wherein the one or more energy consuming devices comprise an elevator.

14. The method of claim 1, wherein the notification is received from an independent system operator.

15. The method of claim 1, wherein the energy event is a peak capacity of at least a portion of a regional energy power grid.

16. The method of claim 1, wherein the energy event is related to operating the building or facility at an improved energy utilization.

17. The method of claim 16, wherein the energy event is configured to occur periodically.

18. The method of claim 16, wherein the energy event is triggered if the occupancy for at least one of the one or more areas of the building or facility has changed from occupied to unoccupied.

19. The method of claim 1, wherein the one or more systems comprise a building automation system.

20. The method of claim 19, wherein the one or more systems further comprise a security system.

21. The method of claim 19, wherein the one or more systems further comprise a life and safety system.

22. The method of claim 1, wherein the energy reduction mode initiation further comprises initiating a timer having a predefined duration.

23. The method of claim 22, wherein the energy event mode termination occurs upon the expiration of the predefined duration of the timer.

24. The method of claim 1, wherein the energy reduction mode initiation is executed by an automated demand response software program configured within at least one of the one or more systems.

25. The method of claim 1, wherein the energy reduction mode initiation is executed by an automated demand response unit configured external to at least one of the one or more systems.

26. The method of claim 1, wherein the building or facility comprises a commercial building.

27. The method of claim 1, wherein the building or facility comprises commercial retail.

28. The method of claim 1, wherein the building or facility comprises an industrial facility.

29. The method of claim 1, wherein the first and second communications comprise executing one or more functions of an interface of the at least one of the one or more systems.

30. The method of claim 1, wherein the first and second communications comprise sending an electrical signal to the at least one of the one or more systems.

31. The method of claim 1, wherein the first and second communications comprise sending a code to the at least one of the one or more systems.

32. The method of claim 1, wherein operating the one or more of the energy consuming devices at the reduced energy mode comprises providing self-generated electric power to the respective energy consuming devices.

33. The method of claim 1, wherein operating the one or more of the energy consuming devices at the reduced energy mode comprises reducing the power consumption of the respective energy consuming devices.

34. The method of claim 1, wherein the one or more areas of the building or facility comprise individual rooms of the building or facility.

35. The method of claim 1, wherein the one or more areas of the building or facility comprise tenant offices of the building or facility.

36. The method of claim 1, wherein the one or more areas of the building or facility comprise floors of the building or facility.

37. A system for improved energy utilization of a building or facility, wherein the building or facility includes one or more systems each controlling one or more energy consuming devices initially operated with a normal energy consumption, the system comprising:
an automated demand response unit in communication with at least one of the one or more systems;
an network interface in communication with the automated demand response unit and an independent system operator; and
wherein the automated demand response unit is configured to:
receive notification of an energy event, via the network interface, requiring a reduction of energy consumption within the building or facility,
determine an occupancy of one or more areas of the building or facility using at least one of the one or more energy consuming devices,
initiate an energy reduction mode upon receipt of the notification of the energy event, wherein the energy reduction mode initiation comprises sending a first communication to at least one of the one or more systems requesting the respective systems to operate one or more of the energy consuming devices with a reduced energy consumption during the energy reduction mode, and wherein the first communication includes the determined occupancy of the one or more areas of the building or facility, and
terminate the energy reduction mode at the conclusion of the energy event, wherein the energy reduction mode termination comprises sending a second communication to at least one of the one or more systems requesting the respective systems to operate one or more of the energy consuming devices with the normal energy consumption at the conclusion of the energy event.

38. A method for improved energy utilization of a building or facility, wherein the building or facility includes one or more systems each controlling one or more energy consuming devices initially operated with a normal energy consumption, the method comprising:
determining an occupancy of one or more areas of the building or facility using at least one of the one or more energy consuming devices;
initiating an energy reduction mode, wherein the energy reduction mode initiation comprises sending a first communication to at least one of the one or more systems requesting the respective systems to operate one or more of the energy consuming devices with a reduced energy consumption during the energy reduction mode, and wherein the first communication includes the determined occupancy of the one or more areas of the building or facility; and
terminating the energy reduction mode, wherein the energy reduction mode termination comprises sending a second communication to at least one of the one or more systems requesting the respective systems to operate one or more of the energy consuming devices with the normal energy consumption.

39. The method of claim 38, further comprising:
periodically determining the occupancy of the one or more areas of the building or facility using at least one of the one or more energy consuming devices; and
sending an updated occupancy of at least one of the one or more areas of the building or facility to at least one of the one or more systems if the occupancy for the respective area has changed.

40. The method of claim 38, wherein the energy reduction mode is related to operating the building or facility at an improved energy utilization.

41. The method of claim 39, wherein the energy reduction mode initiation is triggered if the determined occupancy of at least one of the one or more areas indicates that the respective areas are unoccupied.

42. The method of claim 41, wherein the energy reduction mode termination is triggered if the determined occupancy of at least one of the one or more areas indicates that the respective areas are occupied.
